(19) United States
(12) Patent Application Publication
(10) Pub. No.: US 2008/0243434 A1
(43) Pub. Date: Oct. 2, 2008

(54) Method Of Identifying Abnormal Operation Of A Machine And An Apparatus Therefor

(75) Inventor: Arnaud Boutin, Chateauroux (FR)

Correspondence Address: MEADWESTVACO CORPORATION, 1021 MAIN CAMPUS DRIVE, CENTENNIAL CAMPUS, RALEIGH, NC, 27606, US

(73) Assignee: MEADWESTVACO PACKAGING SYSTEMS LLC, Stamford,7 (US)

(21) Appl. No.: 11/575,558

(22) PCT Filed: Jul. 18, 2005
(86) PCT No.: PCT/US05/25360

§ 371 Date: Jan. 17, 2008

(30) Foreign Application Priority Data
Jul. 16, 2004 (GB) 0415951.3

(51) Int. Cl. G06F 15/00; G06F 17/18

(52) U.S. Cl. 702/179; 702/183

(57) ABSTRACT

A method of identifying abnormal operation of an industrial machine includes the step of determining statistical parameters from a plurality of samples of characteristic parameter(s) of known similar industrial machines in normal operation and storing them, the statistical parameters defining a statistical range of values of the characteristic parameter(s) for normal operation of the industrial machine. The characteristic parameter(s) of a machine being monitored are sampled and a determination (702) is made as to whether sampled characteristic parameter(s) falls within the statistical range of values for normal operation of the industrial machine. If the sampled characteristic parameter falls outside the statistical range of values for normal operation of the industrial machine an alarm signal is generated (706).

### BACKGROUND OF THE INVENTION

The present invention relates to a system for identifying abnormal operation of an industrial machine, for example, a packaging machine of the type used to package consumer products such as cans and bottles into multiple packaged cartons. The present invention also relates to a method of identifying abnormal operation of an industrial machine for the same purpose.

The majority of known packaging machines are dedicated machines which can construct only one size or type of carton. Therefore, modern bottling plants are required to use several packaging machines to package different carton types. Some packaging machines are capable of packaging different types or sizes of cartons. All such machines require adjustment when switching from one size or type of carton to another.

Packaging machines will typically package approximately 60,000 to 200,000 articles per hour and are required to run continuously for long periods of time. A machine failure means that the machine cannot be used (known as “down time”), which is an expensive delay in a bottling plant. Such a delay will usually result in down time for the entire bottling line, not just the packaging machine, particularly if problems have arisen.

### SUMMARY OF THE INVENTION

According to a first aspect of the present invention, there is provided an apparatus for identifying abnormal operation of an industrial machine, the apparatus comprising a sampling unit arranged to sample at least one characteristic parameter of the industrial machine, a storage device for storing predetermined statistical parameters determined from a plurality of samples of the characteristic parameter(s) of known similar industrial machines in normal operation, the statistical parameters defining a statistical range of values of the at least one characteristic parameter for normal operation of the industrial machine, and a processing unit coupled to a storage device and to the sampling unit for determining whether the at least one sampled characteristic parameter falls within the statistical range of values for normal operation of the industrial machine and for generating an alarm signal if the at least one sampled characteristic parameter falls outside the statistical range of values for normal operation of the industrial machine.

In a preferred embodiment, the processing unit scales the at least one sampled characteristic parameter to the statistical range of values for normal operation of the industrial machine prior to the determination by the processing unit whether the at least one sampled characteristic parameter is within the statistical range of values for normal operation of the industrial machine.

The processing unit preferably generates the alarm signal depending on how far from the statistical range of values for normal operation of the industrial machine the at least one sampled characteristic parameter is determined to be.

The processing unit preferably generates the alarm signal depending on a degree of error of the statistical range of values for normal operation of the industrial machine.

Preferably, the processing unit scales the samples of the characteristic parameter(s) of the known similar industrial machines in normal operation so that they correspond to each other prior to determining the statistical parameters defining the statistical range of values of the at least one characteristic parameter for normal operation of the packaging machine.

The industrial machine may be a packaging machine and the at least one characteristic parameter preferably comprises a signal corresponding, in use, to torque values of a servo-motor used in the industrial machine.

Preferably, the predetermined statistical parameters are determined so that the statistical range of values defines a Normal Distribution Curve, wherein the predetermined statistical parameters are the mean and the variance or standard deviation.

According to a second aspect, the invention provides a method of identifying abnormal operation of an industrial machine, the method comprising the steps of sampling at least one characteristic parameter of the industrial machine, retrieving previously stored statistical parameters determined from a plurality of samples of the characteristic parameter(s) of known similar industrial machines in normal operation, the statistical parameters defining a statistical range of values of the at least one characteristic parameter for normal operation of the industrial machine, determining whether the at least one sampled characteristic parameter falls within the statistical range of values for normal operation of the industrial machine, and generating an alarm signal if the at least one sampled characteristic parameter falls outside the statistical range of values for normal operation of the industrial machine.

In a preferred embodiment, the method, further comprises the step of scaling the at least one sampled characteristic parameter to the statistical range of values for normal operation of the industrial machine prior to the step of determining whether the at least one sampled characteristic parameter is within the statistical range of values for normal operation of the industrial machine.

The step of generating the alarm signal preferably depends on how far from the statistical range of values for normal operation of the industrial machine the at least one sampled characteristic parameter is determined to be.

The step of generating the alarm signal preferably depends on a degree of error of the statistical range of values for normal operation of the industrial machine.

The method preferably further comprises the step of scaling the samples of the characteristic parameter(s) of the known similar industrial machines in normal operation so that they correspond to each other prior to determining the statistical parameters defining the statistical range of values of the at least one characteristic parameter for normal operation of the packaging machine.

Preferably, the predetermined statistical parameters are determined so that the statistical range of values defines a Normal Distribution Curve, wherein the predetermined statistical parameters are the mean and the variance or standard deviation.

According to a further aspect of the present invention, there is provided a computer program element comprising computer program means to make a computer execute the method described above. Preferably, the computer program element as is embodied on a computer readable medium.

It is thus possible to provide an apparatus for identifying abnormal operation of an industrial machine that overcomes the technical and commercial disadvantages of known systems. In particular, it is possible to provide an alarm signal to an operator to provide an indication that preventative maintenance for likely problems prior to any catastrophic failure of the machine may be necessary.

### BRIEF DESCRIPTION OF THE DRAWINGS

One embodiment of the invention will now be more fully described, by way of example, with reference to the drawings, of which:

FIG. 1 is a schematic diagram of part of a packaging system including a diagnostic apparatus constituting an embodiment of the present invention;

FIG. 2 is a schematic block diagram showing the inputs and outputs of the controller used in the diagnostic apparatus of FIG. 1;

FIG. 3 is a schematic diagram of the controller used in the diagnostic apparatus of FIG. 1; and

FIGS. 4 and 5 are flow diagrams of a data processing method for use by the controller of FIG. 2.

FIG. 6 is a schematic diagram of a packaging system in which the present invention could be utilized.

### DETAILED DESCRIPTION OF THE PREFERRED EMBODIMENT

Throughout the following description, identical reference numerals shall be used to identify like parts.

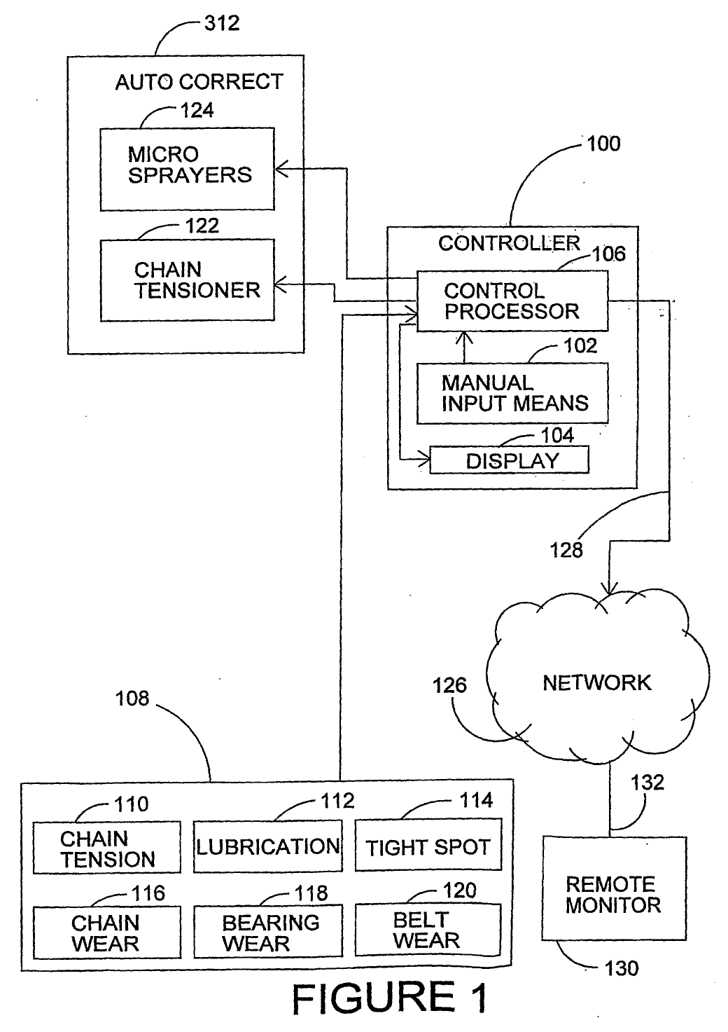

Referring to the drawings and in particular FIG. 1 there is shown a system for integrating electrical and mechanical data and information technology in a packaging machine for improving productivity by forecasting and scheduling maintenance so that down time will not adversely impact production and market needs. The system can be employed generally on servo machines.

The system comprises a controller 100 fitted to a packaging machine (not shown), but is usually incorporated into the existing control means. The controller 100 comprises an input device 102, an output device 104 and a processing unit 106 that supports a user interface presented by the output device 104.

In order to perform condition maintenance, the system includes elements to diagnose problems. To achieve this, there further comprises a number of sensors 108 for monitoring various physical characteristic parameters. The physical parameters can be processed in order to provide additional characteristic parameters, as shown in FIG. 1. For example, a signal corresponding to a torque of a motor can undergo spectral analysis, an amplitude at a specific frequency revealed by the spectral analysis being of use as a parameter in a diagnostic process. Whilst, in at least one example of the present invention contained herein, sensors are employed in order to probe physical parameters, direct evaluation of physical parameters by a device constituting a sensor is possible. An example of such a sensor is a servo-motor as it is able to provide a signal corresponding to the torque of the servo-motor.

For example, to monitor the various chain or belt assemblies, the chain tension 110 is monitored by measuring and processing the torque of the servo motor driving each chain.

Preferably, the lubrication 112 is analysed by measuring the servo motor torque to diagnose for poor lubrication.

This system is also used to diagnose a ‘tight spot’ 114. In a packaging machine, the ‘tight spot’ occurs when the package binds with one of the guides or moving parts on a conveyor or chain due to glass, paper, dust, glue, etc. which will result in the conveyor chain/belt jolting.

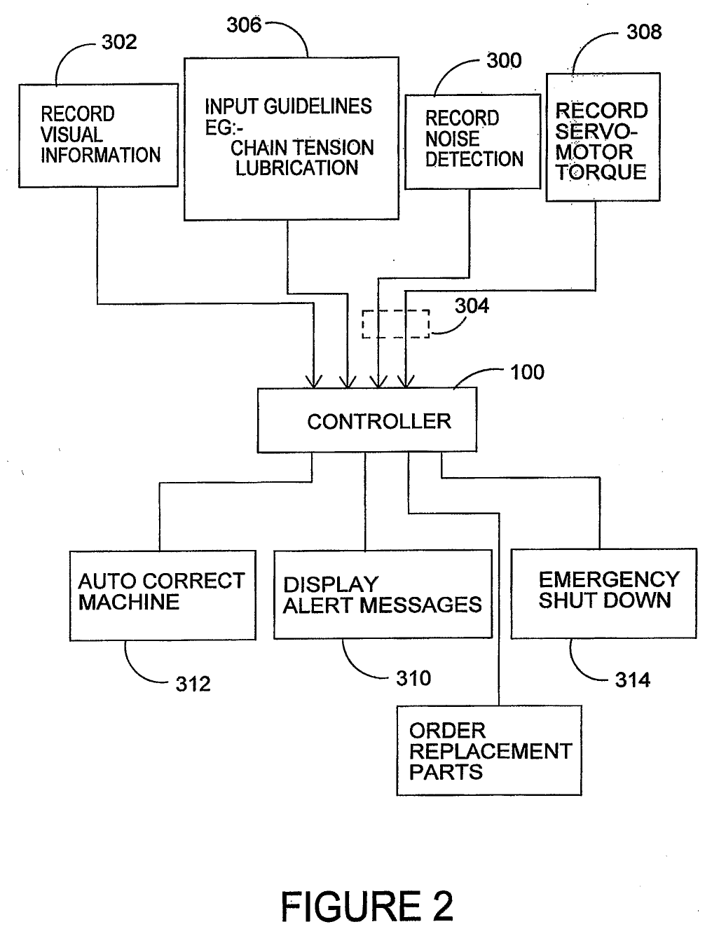

Sensors may also be used to monitor one or more of chain wear 116, bearing wear 118 and/or belt wear 120, again by monitoring the servo motor torque to diagnose one assembly chains or belts. Referring to FIG. 2, for bearing wear analysis, a noise detection device 300 can be used in addition to, or as an alternative, to locate the particular position of a worn bearing.

Optionally, visual information 302 about the condition of the machine, for example monitoring star wheel condition, jam induced with an article, is recorded by high speed cameras and fed to the controller 100 where a file is generated and saved in the hard disk of a PC within the system.

In some embodiments, the signal from the sensor 108 will be filtered through known electronic filters 304 to reduce the background noise in the signal.

Pre-programmed statistical parameters 306 for the various characteristic parameters being monitored are entered into the controller by pre-programming the system. The statistical parameters can be used as inputs for a computing system in order to evaluate the level of a specific problem, for example the chain tension evaluated using specific parameters and compared with upper and lower tolerance limits. The manner in which these pre-programmed statistical parameters are provided will be described in more detail below.

Information from the servo motor sensors 308, detected noise from the noise detection device 300 and visual information 302 is input into the control processor 106 and compared to the pre-programmed statistical parameters for each servo motor or machine assembly or module. If the input measurement from the sensors is not within a predetermined range or tolerance limit, then the control processor 106 will issue an alert message 310 and the measurement compared to various known parameters for faults in the machine so as to display the fault. For example, if a chain is subjected to the tight spot, the torque measurement will indicate that there are a number of spikes at regular intermittent intervals and the processor will display an alert message. If the chain tension deviates either above or below the predetermined range, this will indicate the tension of the chain is too loose or too tight. Again, a message is communicated to the user via the display.

The operator will then intervene to correct the problem, or will monitor it more closely until scheduled maintenance.

Optionally, the controller 100 may include a fail safe monitoring parameter so that if there is a serious problem, for example the measurements exceed pre-programmed safe working parameters, the controller will output a signal to automatically shut down the machine 314.

With certain parameters it is possible to automatically correct 312 the defect and various auto-correction devices are employed in the machine. In the illustrated embodiment of FIG. 1, the system includes a chain tensioner 122 controlled by the controller to be automatically introduced or moved thereby to increase or decrease the tension of the chain so as to return the servo-motor torque to within the pre-programmed range. Similarly, if it appears that the lubrication has deteriorated then micro-sprayers 124 are switched on by the controller 100 to lubricate the chains automatically and without the need for turning the machine off. If the problem is caused by a part that is worn and needs replacing, spare parts can be automatically ordered 316.

The information recorded by the controller 100 is stored on hard disc or other storage medium to be used to monitor the performance of the machine remotely from the packaging plant. Remote monitoring is achieved by coupling the controller 100 to a communications network 126 via a first communications link 128. A server 130 is coupled to the communications network via a second communications link 132. In the present example, the communications network is the Internet and so the controller 100 is capable of communicating packets of data with the server 130 which are routed through the Internet to a remote monitor.

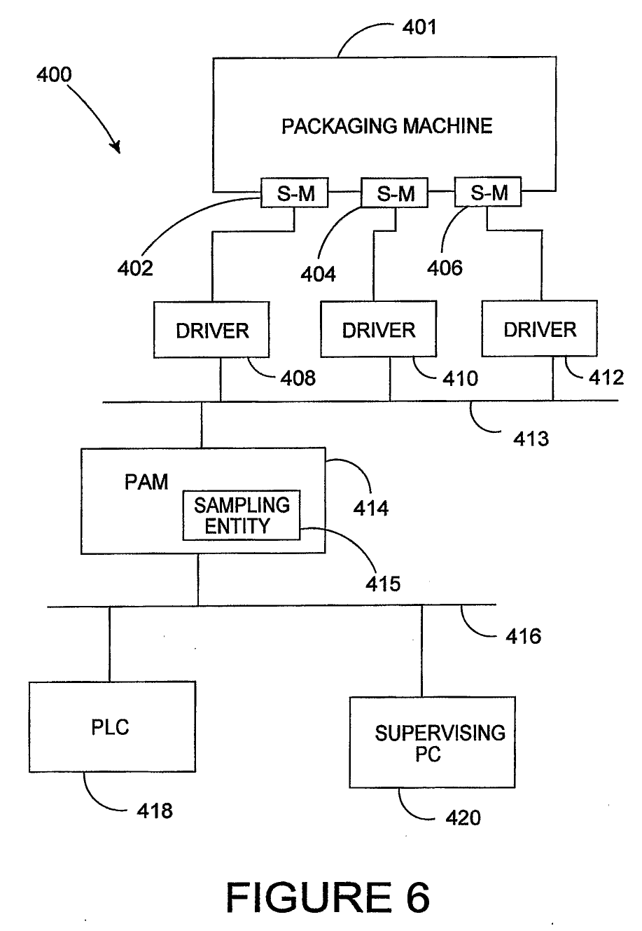

Referring to FIG. 6, there is shown a packaging system 400 in which the present invention could be utilised comprising a packaging machine 401 to which a first servo-motor 402, a second servo-motor 404 and a third servo-motor 406 are coupled. A first driver unit 408, a second driver unit 410 and a third driver unit 412 are coupled to the first, second and third servo-motors 402, 404, 406 respectively. In this example the first, second and third driver units 408, 410, 412 are SAM Smart Digital Drives of the type manufactured by Inmotion™ Technologies, although it will be appreciated that other suitable drivers can be used.

Each of the first, second and third driver units 408, 410, 412 is coupled to a data bus 413, the data bus 413 also being coupled to a driver management unit 414. In this example, the driver management unit 414 is a Programmable Axis Manager (PAM) manufactured by Inmotion™ Technologies, although it will again be appreciated that any suitable driver management equipment can be employed.

The PAM 414 supports a real-time task 415 that periodically samples a driving signal issued by any one or more of the first, second or third driver units 408, 410, 412 respectively to the first, second or third servo-motors 402, 404, 406. The task 415 is activated, for example, every 10 ms if a sampling frequency of, for example, 100 Hz is required. The driving signals sampled by the task 415 also correspond to torque of the respective servo-motor.

The PAM 414 is coupled to a Local Area Network (LAN) 416, the LAN 416 being coupled to a Programmable Logic Controller 418 and a supervising computer 420. In this example, the supervising computer 420 is a Personal Computer (PC).

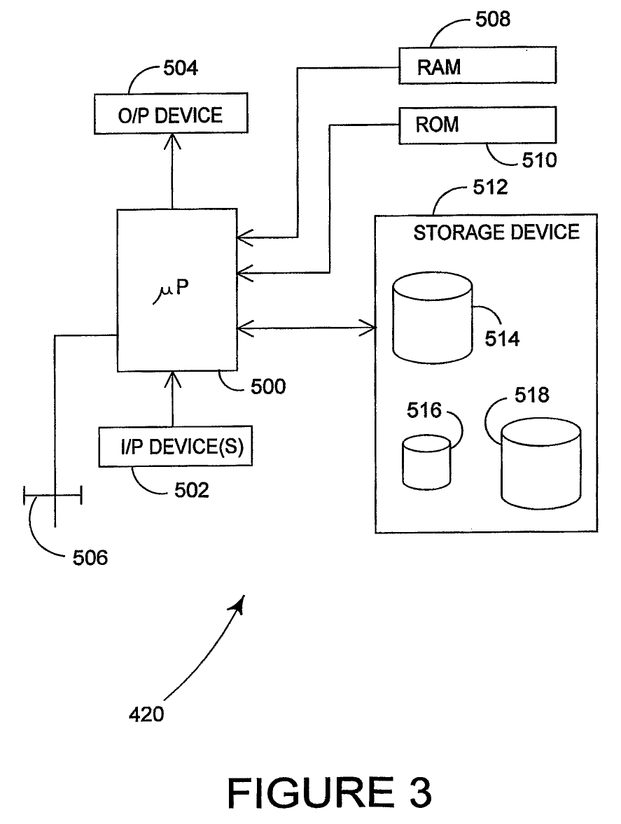

Referring to FIG. 3, the controller 100 comprises a processing unit or processor 500, to which one or more input devices 502, such as a keyboard and/or a mouse, and an output device 504 such as a display, are coupled. The processor 500 is also coupled to an Input/Output (I/O) port 506, the I/O port 506 being coupled, in this example, to a port (not shown) of a LAN.

A first storage device, for example a volatile memory, such as Random Access Memory (RAM) 508, is coupled to the processor 500. A second storage device, for example a non-volatile memory, such as Read Only Memory (ROM) 510, is also coupled to the processor 500. As is common with most PCs, the processor 500 is also coupled to a third, re-writable non-volatile, storage device, for example, a so-called hard drive, or Hard Disc Drive (HDD) 512. The hard drive 512, in this example, stores, inter alia, a first database 514, a second database 516, and a third database 518. However, content of the first, second and third databases 514, 516, 518 need not be stored in a formal database structure provided by many well-known software packages, and can instead be stored, for example, as a simple look-up table.

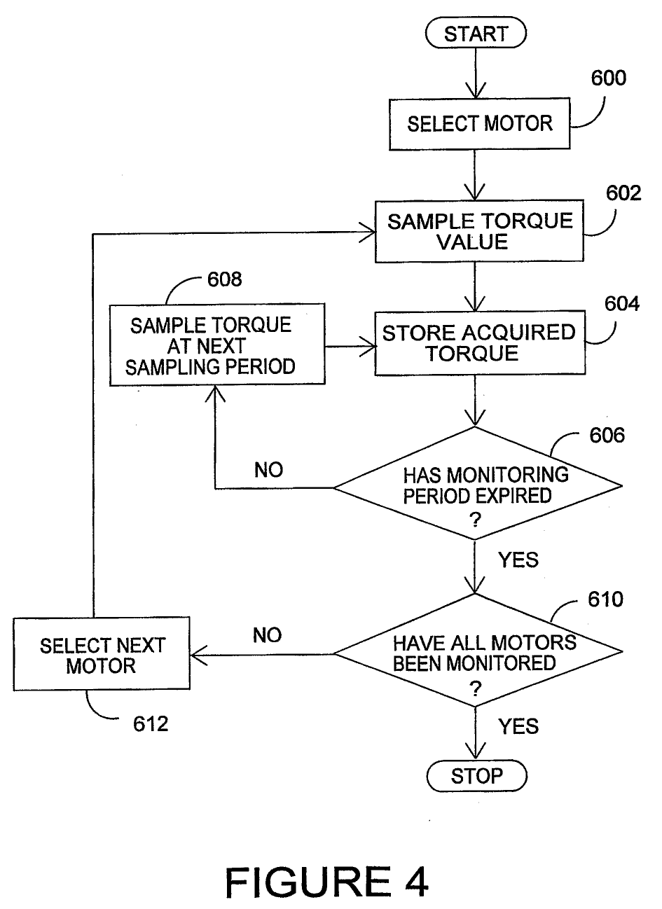

In operation (FIG. 4), the controller 100 supports a monitoring cycle and a diagnosis cycle in order to identify abnormal or potentially abnormal operation of the packaging machine.

With respect to FIG. 4, the controller 100 identifies and selects (step 600) a first parameter, for example a first servo-motor from a plurality of servo-motors in the packaging machine to monitor over a predetermined period of time at a predetermined sampling rate. The controller 100 then interrogates a driver management unit for samples of a first driving signal issued to the first servo-motor. The samples of the first driving signal so obtained (step 602) are then communicated to the controller 100, the first driving signal issued to the first servo-motor by the first driver unit corresponding to a first torque exerted by the first servo-motor. Similarly, a second driving signal and a third driving signal respectively issued by the second and third driving units respectively correspond to second and third torques exerted by the second and third servo-motors.

The sample of the first driving signal is subsequently stored (step 604) by the supervising computer in the first database 514. After storing the sample of the first driving signal, the controller 100 determines (step 606) if the period over which the first driving signal is sampled has expired. If the period has not expired the controller 100 obtains (step 608) another sample of the first driving signal from the driver management unit in respect of a subsequent sampling period and stores (step 604) this most recent sample.

If the period over which the driving signal is sampled has expired, the controller 100 determines (step 610) if driving signals imposed upon other servo-motors, such as the second or third servo-motors need to be sampled. If, in this example, the second or the third servo-motor still needs to be monitored, the controller 100 selects (step 612) one of the second or the third servo-motors for monitoring. The above-described sampling procedure is then repeated for the driving signal issued to the next selected servo-motor. Indeed, the above process of selection of servo-motors is repeated until all of the servo-motors have been monitored. The above monitoring procedure is then repeated after a predetermined period of time. Further information regarding this process can be found in PCT Patent Specification No. WO 03/025862.

For example, pre-processed first samples may be subjected to spectral analysis by a spectrum analyser module (not shown) supported by the controller 100. In this example, the processor 500 carries out a Fast Fourier Transfer (FFT). The FFT of the pre-processed first samples yields a spectrum which reveals much information not only about the operation of the first servo-motor, but also one or more mechanical element coupled directly, or indirectly, to the first servo-motor. In this, and other, examples, a sub-assembly of the packaging machine comprises the one or more mechanical element.

If required, filters can be used to “clean-up” sampled driver signals so as to facilitate improved accuracy of spectral analysis.

Following generation of the spectrum for the pre-processed first samples, the second database 516 is interrogated (step to obtain information relating to one or more relevant parameter extractable from the spectrum by analysis thereof, and corresponding to one or more known causes of abnormal operation of the packaging machine. In this example, for a given sub-assembly associated with the spectrum, dry friction, oily friction, sprocket engagement frequency, and lug frequency are some of the pre-programmed parameters for which values corresponding to these parameters can be ascertained from the spectrum. Consequently, for a given parameter such as dry friction, the second database 516 comprises a number of statistical parameters for each characteristic. Once the relevant pre-programmed parameters along with the identity of one or more frequency characteristic of each relevant parameter have been obtained from the second database 516, the amplitude(s) at the identified one or more frequency is/are determined from the spectrum and stored in the second database 516.

The pre-programmed statistical parameters are originally determined by performing statistical analysis on a number of samples of the characteristic parameter obtained from one or more machines of the same or similar type that are known to be operating correctly. For example, although a machine may be similar, it may have characteristics that cannot be applied directly to the machine under test. However, by scaling the characteristic parameters for all the similar (or same) types of machines, a set of samples can be obtained that can be used to provide statistical data that is normalised. The normalised data is used to determine statistical parameters, for example mean μ and variance □² or standard deviation □. This analysis assumes that the characteristic parameter for a correctly operating machine will lie within a standard “Bell-shaped” distribution (a Normal distribution curve) given by the following equation:

$$N ( μ , {σ}^{2} ) = \frac{1}{σ \sqrt{2 π}} {e}^{- \frac{{( x - μ )}^{2}}{2 {σ}^{2}}}$$

The statistical parameters determined from the analysis are then used to determine whether the measured characteristic parameter sensed (and, possibly, pre-processed) from the machine being monitored or tested, lies within the Normal distribution and how far from the distribution curve it lies. This information can then be compared to threshold levels to determine what kind of alarm should be triggered, for example, whether it is only the display for the operator to indicate that the machine element is beginning to diverge from the average, but maintenance can wait, or if, at the other extreme, the element is so far from the average that it is expected that it could fail at any time, and therefore the machine is automatically shut down before the part fails and, potentially causes damage.

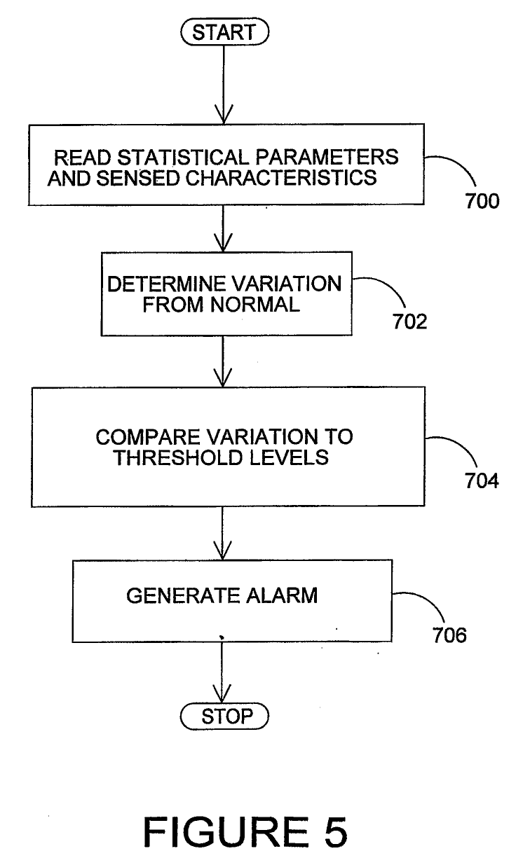

This is best shown in FIG. 5, where the pre-programmed statistical parameters and the sensed (and, possibly pre-processed) characteristic parameters are read (step 700) by the processor 500 from the storage device 512. The statistical parameters are then used to determine whether the sensed characteristic parameters fall within the Normal distribution curve for that machine or module and by how far they vary from the average (step 702). The magnitude of that variation is then compared (step 704) to preset threshold levels, also pre-stored in the storage device 512, and the controller then generates any one of several different alarm options, depending on which threshold level is exceeded.

Upon detection of abnormal operation, information relating to the abnormal operation of the packaging machine 401 can be communicated to a service engineer, for example, via the display 504. Additionally, or alternatively, the supervising computer 420 can issue an instruction to the PLC 418 to activate the auto-correction device, such as the micro-sprayers attached to the packaging machine 401 in order to provide corrective maintenance to the one or more mechanical element to cause the packaging machine 401 to revert to a state of normal operation. Other corrective, or preventative, measures already described above in previous examples can also be employed. For example, an escalated alarm may advise the operator that there is a fault, so that the operator can stop the machine as soon as possible, and the highest level of alarm may mean that the controller automatically stops the operation of the machine immediately. It will, of course, be apparent that other desired alarm generated actions, may be used, if desired.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device.

1. An apparatus for identifying abnormal operation of a sub-assembly of an industrial machine having at least one servo motor, the apparatus comprising:
a sampling unit arranged to sample at least one characteristic parameter of the industrial machine, said at least one characteristic parameter comprising signal corresponding, in use, to torque values of said servo-motor;
a storage device for storing predetermined statistical parameters determined from a plurality of sample of the characteristic parameter(s) of known similar industrial machines having similar sub-assemblies, that are known to be operating correctly, the statistical parameters defining a statistical range of values of the at least one characteristic parameter for normal operation of said sub-assembly; and
a processing unit coupled to a storage device and to the sampling unit for determining whether the at least one sampled characteristic parameter falls within the statistical range of values for normal operation of the industrial machine and for generating an alarm signal if the at least one sampled characteristic parameter falls outside the statistical range of values for normal operation of the industrial machine, wherein the processing unit scales the at least one sampled characteristic parameter to the statistical range of values for normal operation of the industrial machine prior to the determination by the processing unit whether the at least one sampled characteristic parameter is within the statistical range of values for normal operation of the industrial machine.

2. An apparatus as claimed in claim 1 wherein the processing unit generates the alarm signal depending on how far from the statistical range of values for normal operation of the industrial machine the at least one sampled characteristic parameter is determined to be.

3. An apparatus as claimed in claim 1, wherein the processing unit generates the alarm signal depending on a calculated degree of error of the statistical range of values for normal operation of the sub-assembly of the industrial machine.

4. An apparatus as claimed in claim 1, wherein the processing unit scales the samples of the characteristic parameters from the known similar sub-assemblies of similar industrial machines, in normal operation, so that they correspond to each other prior to determining the statistical parameter defining the statistical range of values of the at least one characteristic parameter for normal operation of the packaging machine.

5. An apparatus as claimed in claim 1, wherein the industrial machine is a packaging machine.

6. An apparatus as claimed in claim 1, wherein the at least one characteristic parameter comprised a signal corresponding, in use, to torque values of a servo-motor used in the industrial machine.

7. An apparatus as claimed in claim 1, wherein the predetermined statistical parameters are determined so that the statistical parameters are the mean and the variance.

8. A method of identifying abnormal operation of a sub-assembly of an industrial machine having at least one servo motor, the method comprising the steps of:
sampling at least one characteristic parameter of the industrial machine, said at least one characteristic parameter comprising, a signal corresponding, in use, to torque values of said servo-motor;
retrieving previously stored statistical parameters determined from a plurality of samples of the characteristic parameter(s) of known similar industrial machines having similar sub-assemblies, that are known to be operating correctly, the statistical parameters defining a statistical range or values of the at least one characteristic parameter for normal operation of said sub-assembly of the industrial machine;
determining whether the at least one sampled characteristic parameter falls within the statistical range of values for normal operation of the industrial machine; and
generating an alarm signal if the at least one sampled characteristic parameter falls outside the statistical range of values for normal operation of the industrial machine, wherein the processing unit scales the at least one sampled characteristic parameter to the statistical range of values for normal operation of the industrial machine prior to the determination by the processing unit whether the at least one sampled characteristic parameter is within the statistical range of values for normal operation of the industrial machine.

9. The method of claim 8, wherein the step of generation the alarm signal depends on how far from the statistical range of values for normal operation of the industrial machine the at least one sampled characteristic parameter is determined to be.

10. The method of claim 8, wherein the step of generating the alarm signal depends on a degree of error of the statistical range of values for normal operation of the industrial machine.

11. The method of claim 8, further comprising the step of scaling the samples of the characteristic parameter(s) of the known similar industrial machines in normal operation so that they correspond to each other prior to determining the statistical parameters defining the statistical range of values of the at least one characteristic parameter for normal operation of the packing machine.

12. The method of claim 8, wherein the predetermined statistical parameters are determined so that the statistical range of values defines a Normal Distribution Curve, wherein the predetermined statistical parameters are the mean and the variance.

13. (canceled)

14. (canceled)

15. (canceled)

16. (canceled)
